(19) United States
(12) Patent Application Publication
(10) Pub. No.: US 2002/0010940 A1
(43) Pub. Date: Jan. 24, 2002

(54) Two-conductor medium communication systems and methods for transmission and reception of multiple-channel data signals

(76) Inventors: James J. Hornsby, Newbury Park, CA (US); Kris Kelkar, Camarillo, CA (US)

Correspondence Address: KOPPEL & JACOBS, 555 St. Charles Drive, Suite 107, Thousand Oaks, CA, 91360, US

(21) Appl. No.: 09/855,424

(22) Filed: May 14, 2001

Related U.S. Application Data
(60) Provisional application No. 60/205,005, filed on May 17, 2000.

(51) Int. Cl. H04N 7/173

(52) U.S. Cl. 725/98

(57) ABSTRACT

Communication systems and methods are provided for communicating data signals over a plurality of different respective communication channels. The systems are realized with sets of signal filters wherein each filter set defines a respective communication channel. The filters of each set are distributed among transceivers which are coupled together with a two-conductor medium. The systems and methods provide communication to a significant number of communication end-users over a substantial number of communication channels without the need for complex modulation and demodulation hardware.

### CROSS REFERENCES TO RELATED APPLICATIONS

This application claims the benefit of U.S. Provisional Application Ser. No. 60/205,005 filed May 17, 2000.

### BACKGROUND OF THE INVENTION

1. Field of the Invention

The present invention relates generally to communication systems.

2. Description of the Related Art

Conventional communication systems have typically utilized signal carriers to separate different information channels and compact multiple channels into a specific frequency range. The channel bandwidths are preferably narrowed in order to fit more channels into the specific frequency range and this narrowing is generally realized with various modulation schemes (e.g., m-ary bi-orthogonal keying). These modulation schemes, however, add significant cost to a communication system because they are parts-intensive and generally require complex digital signal processing techniques to modulate and demodulate data.

### BRIEF SUMMARY OF THE INVENTION

The present invention is directed to simple, inexpensive communication systems for communicating data signals over a plurality of different respective communication channels.

These systems are realized with sets of signal filters wherein each filter set defines a respective communication channel. The filters of each set are distributed among transceivers which are coupled together with a two-conductor medium. Accordingly, a significant number of communication end-users and a system headend can share data signals over a substantial number of communication channels without the need for complex modulation and demodulation hardware.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a block diagram of a communication system embodiment of the present invention;

FIG. 2 is a block diagram of a transmitter embodiment in the communication system of FIG. 1;

FIG. 3 is a diagram of exemplary frequency allocations in the communication system of FIG. 1

FIG. 4 is a block diagram of a receiver embodiment in the communication system of FIG. 1; and

FIG. 5 is a flow chart which shows communication processes that can be practiced with the communication system of FIG. 1.

### DETAILED DESCRIPTION OF THE INVENTION

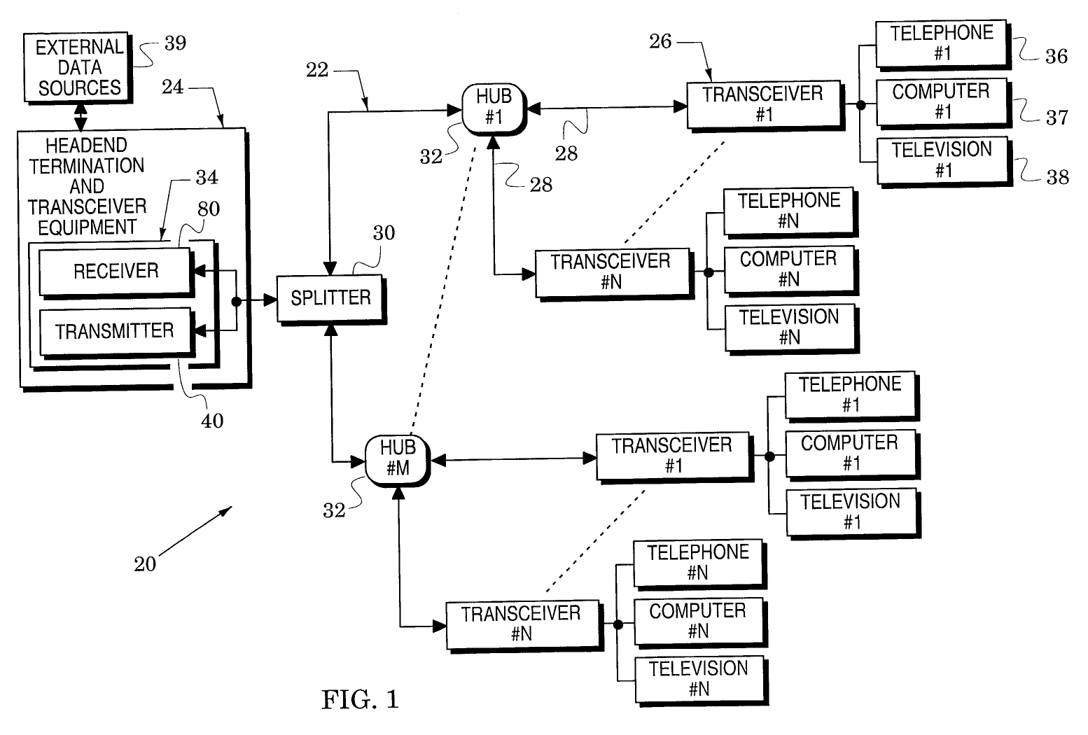

FIG. 1 illustrates a data communication system 20 of the invention that facilitates communication of data signals over a two-conductor medium 22 between a headend 24 of the system and transceivers 26 of end-users of the system. In particular, FIG. 1 shows that the medium (e.g., a coaxial cable or a twisted pair) is generally formed by a network of medium branches 28 that are joined with signal-steering devices such as a signal splitter 30 and hubs 32.

The headend has a headend transceiver 34 that is coupled to one of the medium branches and the end-user transceivers 26 are coupled to respective ones of the other medium branches. Medium branches 28 are preferably coupled to hubs 32 so that N end-user transceivers 26 are coupled to the medium 22 via each respective one of M hubs 32.

Each of the end-user transceivers 26 facilitates data communication over the medium 22 for a variety of end-user data devices such as telephones 36, personal computers 37 and televisions 38. Although this communication can be between end-users of the communication system 20, it is generally through the headend 24 to external data sources 39 (e.g., satellites and the internet).

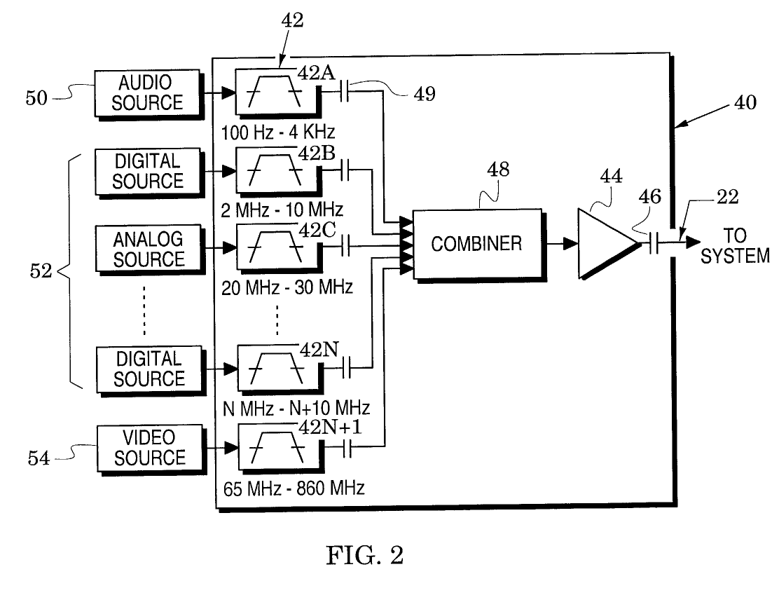

FIG. 2 illustrates a transmitter embodiment 40 for the headend and end-user transceivers (34 and 26 in FIG. 1). The embodiment 40 includes a plurality of bandpass filters 42, an amplifier 44 that is preferably coupled to the medium (22 in FIG. 1) by a coupling capacitor 46, and a signal combiner 48 that couples the filters to the amplifier. An exemplary combiner is a high-bandwidth operational amplifier in a non-inverting configuration that is coupled to the filters 42 by additional coupling capacitors 49.

The filters 42 have different passbands that each define a respective communication channel of the data communication system (20 in FIG. 1). For example, filter 42A has a passband (e.g., 100 Hz to 4 KHz) suitable for passing an audio transmit signal from an audio source 50 (e.g., a telephone), filters 42B-N have passbands (e.g., with widths on the order of 10 MHz) suitable for passing digital and analog transmit signals from digital and analog sources 52 (e.g., computers), and filter 42N+1 has a video passband (e.g., with a width on the order of 6 MHz) suitable for passing video transmit signals from video sources 54 (e.g., a television set). Accordingly, the filters 42 insure that each source instrument communicates over the medium (22 in FIG. 1) via a respective communication channel.

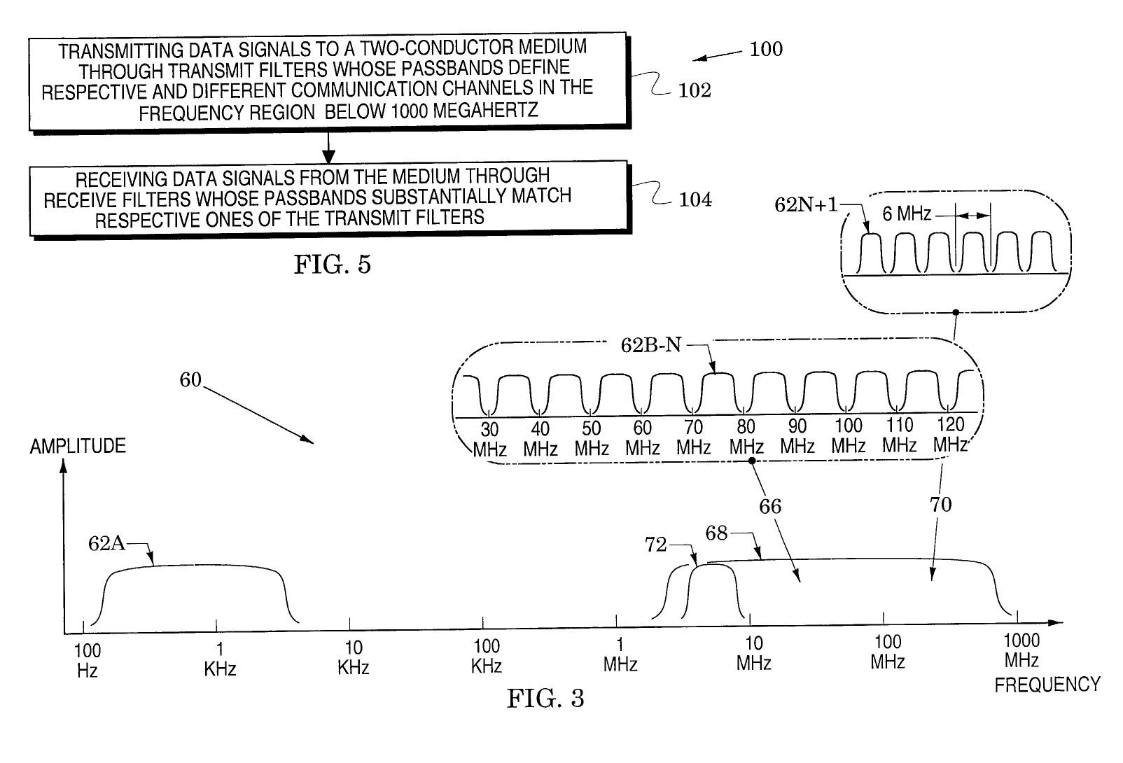

Operation of the transmitter embodiment 40 is best described with reference to the frequency-allocation diagram 60 of FIG. 3. This diagram plots exemplary filter passbands for the transmitter filters (42 in FIG. 2) as a function of a logarithmic frequency coordinate. An exemplary passband 62A of the audio filter (42A in FIG. 2) is shown to extend substantially from 100 Hz to 4 KHz. Exemplary adjacent passbands 62B-N of the digital and analog filters (42B-N in FIG. 2) are shown with widths of substantially 10 MHz that are located, as indicated by the insert 66, in a frequency region 68 which extends from substantially 2 MHz up to the roll-off frequency of typical two-conductor mediums (e.g., 1000 MHz).

The transmit signals that are generated by the audio, digital and analog sources 50 and 52 of FIG. 2 and passed through the filters 42A-N are generally conducted directly by the medium (22 in FIG. 1), i.e., without the aid of a carrier signal. The medium, however, can also conduct carrier signals onto which the communication signals have been modulated.

For example, the video source(s) 54 of FIG. 2 may generate modulated carrier signals and their respective filters 42N+1 may have a plurality of adjacent video passbands 62N+1 in FIG. 3 with exemplary widths on the order of 6 MHz. The passbands 62N+1 are distributed over a video frequency portion (e.g., 65-860 MHz) of the frequency region 68 as indicated by the insert 70.

Another exemplary modulated carrier source that may be communicated by the invention is one associated with a home phone network application (HPNA). This source can also be provided with a respective video filter that has a suitable passband 72 (e.g., with a width of 4 MHz that is centered at substantially 7.5 MHz). Yet another exemplary modulated carrier source is one associated with Ethernet systems that generally operate in the range of 10 megabits/second and this source could also be provided with a respective transmit filter.

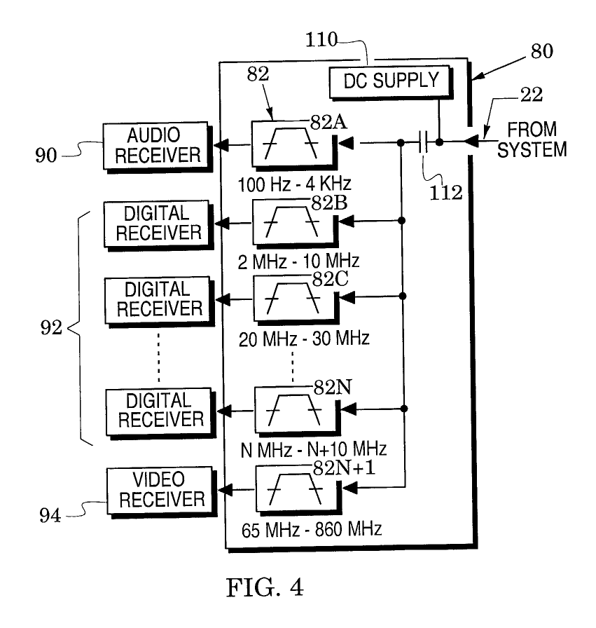

Each of the transmit filters of the transmitter embodiment 40 of FIG. 2 preferably has a corresponding receive filter in the receiver portion of the transceivers of FIG. 1. FIG. 4 illustrates a receiver embodiment 80 for the headend and end-user transceivers (34 and 26 in FIG. 1) that includes receive bandpass filters 82 which provide this operational parameter.

In particular, the receiver 80 has an audio filter 82A whose passband substantially matches the passband of the audio filter 42A of FIG. 2, digital and analog filters 82B-N whose passbands substantially match the passbands of the digital and audio filters 42B-N of FIG. 2, and a video filter 82N+1 whose passband substantially matches the passband of the video filter 42N+1 of FIG. 2.

Transmit signals from any of the transceivers (26 and 34 of FIG. 1) can therefore be passed through a respective one of the receive filters 82 of the receiver 80 of FIG. 4 to a corresponding one of receivers 90, 92 and 94. For example, transmit signals that pass through the audio filter 42A of FIG. 2 can be received from the medium (22 in FIG. 1) via the audio filter 82A of FIG. 4 and provided to an audio receiver 90 (e.g., a telephone).

Similarly, transmit signals that pass through the digital and analog filters 42B-N of FIG. 2 can be received via the digital and analog filters 82B-N of FIG. 4 and provided to digital and analog receivers 92. Finally, transmit signals that pass through the video filter 42N+1 of FIG. 2 can be received via the video filter 82N+1 of FIG. 4 and provided to video receivers 94. Although not shown in FIG. 4, the coupling between the receive filters 80 and the medium may be augmented with an appropriate signal splitting device (e.g., the signal splitter 30 of FIG. 1).

It is apparent that corresponding filters of the transmitter 40 of FIG. 2 and the receiver 80 of FIG. 4 form sets of filters and each filter set defines a respective communication channel in the communication system 20 of FIG. 1. The audio filter 42A of FIG. 2 and the audio filter 82A of FIG. 4, for example, are part of a set of filters that define an audio channel of the system. Similarly, the digital filter 42B of FIG. 2 and the digital filter 82B of FIG. 4 are part of a set of filters that define a digital channel of the system and the video filter 42N+1 of FIG. 2 and the video filter 82N+1 of FIG. 4 are part of a set of filters that define a video channel of the system.

The flow chart 100 of FIG. 5 illustrates process steps in a method of communicating data that can be practiced with the communication system 20 of FIG. 1. In process step 102, data signals are transmitted to a two-conductor medium through transmit filters whose passbands define respective and different communication channels in the frequency region below 1000 megahertz. Subsequently, data signals are received in process step 104 from the medium through a plurality of receive filters whose passbands substantially match respective ones of the transmit filters.

Although energizing power may be provided locally to transceivers of the communication system of FIG. 1, the two-conductor medium 22 provides a conduit for sharing power supplies. A DC power supply 110, for example, is coupled in FIG. 4 to the medium 22 on the system side of a blocking capacitor 112. Accordingly, various elements of the communication system can draw energizing power from the medium 22.

Communication systems have been described which provide secure communication channels for sharing data signals between a system headend and a plurality of system end-users. Because these systems isolate the data signals with respective filter sets that are coupled to a two-conductor medium, they provide substantial cost reduction because they relieve the need for complex signal modulation and demodulation hardware.

Systems of the invention offer data communication to end-users over a significant number of communication channels and the number of end-users can be substantially increased (as shown in FIG. 1) by the use of communication hubs 32 which extend the medium 22 by providing two-way signal amplification.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

We claim:

1. A data communication system, comprising:
a two-conductor medium;
a plurality of transceivers; and
sets of filters wherein the filters of each set are configured to define a respective communication channel over said medium and are coupled to said medium in respective transceivers;
said transceivers thereby enabled to communicate data signals over the respective communication channels of said sets.

2. The system of claim 1, wherein:
each of said transceivers includes an amplifier and a pair of said sets;
one of said pair is a receive set that is coupled to said medium to receive said data signals; and
the other of said pair is a transmit set that is coupled to said medium by said amplifier to transmit said data signals.

3. The system of claim 2, wherein each of said transceivers further includes a combiner that couples said transmit set to said amplifier.

4. The system of claim 1, wherein the filters of each of said sets have a passband that defines that set's respective communication channel.

5. The system of claim 3, wherein said passband lies in the frequency region below 1000 megahertz.

6. The system of claim 3, wherein said passband has a width that does not substantially exceed 10 megahertz.

7. The system of claim 1, wherein said two-conductor medium is a coaxial cable.

8. The system of claim 1, wherein said two-conductor medium is a twisted pair.

9. The system of claim 1, wherein said medium comprises a plurality of medium branches and further including at least one hub transceiver that couples said branches together and amplifies said data signals.

10. A communication system for communicating data signals over a plurality of different communication channels, comprising:
a two-conductor medium; and
a plurality of transceivers that each include:
a) a receiver which has a group of receive filters coupled to receive data signals from said medium; and
b) a transmitter which has a group of transmit filters and an amplifier coupled to transmit data signals from said transmit filters to said medium;
wherein said receive and transmit filters have passbands that are positioned to define said different communication channels.

11. The system of claim 10, wherein said passbands lie in the frequency region below 1000 megahertz.

12. The system of claim 11, wherein said passbands have widths that do not substantially exceed 10 megahertz.

13. The system of claim 10, wherein said two-conductor medium is a coaxial cable.

14. The system of claim 10, wherein said two-conductor medium is a twisted pair.

15. The system of claim 10, wherein the transmitter of each of said transceivers further includes a combiner that couples said transmit filters to said amplifier.

16. The system of claim 10, wherein said medium comprises a plurality of medium branches and further including at least one hub transceiver that couples said branches together and amplifies said data signals.

17. A data communication system for communicating data signals, comprising:
a coaxial cable network;
sets of filters that have passbands that define respective communication channels in the frequency region below 1000 megahertz; and
a plurality of transceivers that each include;
a) a receiver that has a filter of each of said sets coupled to said cable network to receive said data signals;
and
b) a transmitter that has an amplifier and a filter of each of said sets that is coupled by said amplifier to said cable network to transmit said data signals;
said transceivers thereby enabled to communicate said data signals over the respective communication channels of said sets.

18. The system of claim 17, wherein said cable network forms cable branches and further including at least one hub transceiver that couples said cable branches together and amplifies said data signals.

19. The system of claim 17, wherein said passbands have widths that do not substantially exceed 10 megahertz.

20. A method of communicating data signals, comprising the steps of:
transmitting data signals to a two-conductor medium through transmit filters whose passbands define respective and different communication channels in the frequency region below 1000 megahertz; and
receiving data signals from said medium through a plurality of receive filters whose passbands substantially match respective ones of said transmit filters.

21. The method of claim 20, further including the step of amplifying said data signals prior to said transmitting step.

22. The method of claim 20, wherein said two-conductor medium is a cable network that forms cable branches and further including the step of amplifying said data signals as they pass between said cable branches.
